(19) United States
(12) Patent Application Publication
(10) Pub. No.: US 2026/0138894 A1
(43) Pub. Date: May 21, 2026

(54) CLEAN WATER PRODUCTION SYSTEM

(71) Applicant: Heinz RAUBACHER, Vaihingen/Enz (DE)

(72) Inventor: Heinz RAUBACHER, Vaihingen/Enz (DE)

(21) Appl. No.: 19/121,433

(22) PCT Filed: Oct. 20, 2023
(86) PCT No.: PCT/EP2023/079245

§ 371 Date: Apr. 16, 2025

(30) Foreign Application Priority Data
Oct. 27, 2022 (DE) 10 2022 128 519.7

(51) Int. Cl. C02F 1/14; B01D 1/00; B01D 5/00; C02F 1/04; C02F 103/08; C25B 1/04

(52) U.S. Cl. CPC C02F 1/14; B01D 1/0005; B01D 1/0035; B01D 5/006; B01D 5/009; C02F 1/048; C25B 1/04; C02F 2103/08; C02F 2201/005; C02F 2201/007

(57) ABSTRACT

The invention relates to a clean water production system (1) having a water evaporation device (10) which can be arranged to float on a water surface (11), in particular the sea water surface, and which has a concentrator system (3) for densifying and directing sun rays (8) onto a water surface region (11) within the floating frame arrangement (2) and has a water supply device (12) which is arranged between the water surface (11) and the water surface region (11′) exposed to the concentrated sun rays and is designed for metered supply of water from the water surface (11) into the irradiated water surface region (11′) so that water is evaporated in the irradiated water surface region (11′) by the thermal energy of the concentrated sun rays (8′), wherein the clean water production system (1) further has a drainage device by means of which the evaporated water can be supplied to a clean water collection point, in particular via a condensation device (7), and has at least one mechanically and functionally integrated hydrogen production device (40) and/or a photovoltaic device (7). The clean water production system (1) consists of a plurality of modules (14) which are held together by means of a floating frame arrangement (2), wherein at least one module is designed as an A type which comprises a water evaporation device (10), and at least one further module is designed as a B type which comprises a photovoltaic device (7), or is designed as a C type which comprises a hydrogen production device (40), or a plurality of further modules are present, at least one of which is designed as a B type module and at least one of which is designed as a C type module.

The invention relates to a clean water production system having a water evaporation device which can be arranged to float on a water surface, in particular a sea water surface, and having a concentrator system for densifying and directing sun rays onto a water surface region within the floating frame arrangement, and a water supply device, arranged between the water surface and the water surface region exposed to the concentrated sun rays, which water supply device is designed for the metered supply of water from the water surface into the irradiated water surface region, so that water is evaporated in the irradiated water surface region by the thermal energy of the concentrated sun rays, wherein the clean water production system further has a drainage device by means of which the evaporated water can be supplied to a clean water collection point, in particular via a condensation device, and has at least one mechanically and functionally integrated hydrogen production device and/or a photovoltaic device.

A clean water production system in combination with a system for generating electrical energy from solar energy and an electrolysis device for producing hydrogen is specified in US2005/0 109 604 A1 . Such a system is relatively complex to construct and use.

DE 203 12 656 U1 discloses a clean water production system having a solar desalination plant. A supply device for salt water has a floating body with dark, preferably black, absorbent material from which the absorbed water can evaporate and then be collected via an annular channel.

DE 20 2017 002 541 U1 also discloses a clean water production system having a desalination device. This has a transparent cover in a hemispherical or cylindrical shape and an evaporation or collecting tray as a freshwater reservoir, which is mounted on buoyant material. DE 27 30 839 A1 discloses a device for the economical concentration and collection of solar energy, having a movable lens arrangement. A device for generating condensate and a photovoltaic arrangement are also mentioned.

DE 10 2008 045 610 A1 relates to an arrangement for obtaining clean water from natural or waste water by means of heat, wherein condensate formation and the conversion of this condensate into water are intensified. In this process, inlet water enters the interior of a floating structure and is evaporated there.

WO 2019/223 838 A1 presents a device for providing fresh water from sea water, wherein an evaporation tank with inlet and outlet is provided.

Another clean water production system is specified in CN 102923801 A. In this well-known clean water production system, water is evaporated for desalination by means of solar heat over a surface of sea water, which is held in a water tank enclosed by a frame, and fed into a condensation device. In order to provide increased thermal energy on the water surface for evaporation, the solar radiation supplied is bundled onto the water in the tank by means of a concentrator system with a biconvex mirror arrangement. The evaporated water vapor is converted into clean water for further use using the condensation device.

The present invention is based upon the object of providing a clean water production system according to the preamble of claim 1, which offers easily adaptable application possibilities with efficient use of solar energy.

This object is achieved with a clean water production system having the features of claim 1. According to the invention, the clean water production system is composed of a plurality of modules which are held together by means of a floating frame arrangement, wherein at least one module is designed as an A-type which comprises a water evaporation device, and at least one further module is designed as a B-type which comprises a photovoltaic device, or is designed as a C-type which comprises a hydrogen production device, or a plurality of further modules are present, of which at least one is designed as a B-type module and at least one as a C-type module.

The modular design with its various modules and mutually adapted frames allows systems for clean water production, particularly from sea water, along with the use of clean water in conjunction with electrical energy generation and/or hydrogen production (optionally in conjunction with another electrical energy source such as wind energy) to be advantageously adapted to the local and climatic conditions of the site of use. CO₂ emissions are avoided. For example, the water supply device arranged between the water surface and the irradiated water surface region forms a barrier between the large water volume having the water surface and the relatively small volume having the irradiated water surface region, via which barrier a metered water supply into the small volume is achieved. In this way, the heating of the water and the associated evaporation is accelerated compared to direct irradiation of the water surface. The water supply device is advantageously designed such that the amount of water supplied to the small volume corresponds at least approximately to the evaporated or evaporable amount of water in the water surface region. The small volume is also advantageously designed so that the radiated thermal energy effectively heats the water in the small volume to achieve the highest possible evaporation rate (e.g., by at least 10 Kelvin above the temperature of the water surface below—for example, to 60° C. to 70° C. at maximum solar radiation). Water not needed for hydrogen production can be used for drinking water supply or irrigation purposes. The concentrator system serves to heat the water volume in the region of the water surface and can, for example, also be formed by a tube system which itself carries the amount of water to be (at least partially) evaporated.

The water supply device also advantageously has a heat-insulating structure. The metered water supply or water replacement can be passively self-regulating (e.g., via a float valve arrangement or capillary action), or actively controlled or regulated by the activation of an actuator device, e.g., in a valve arrangement.

The module arrangement offers advantageous design and use options because the floating frame arrangement is at least partially tubular—for conducting evaporated water to the clean water collection point—wherein multiple tubes can also be present at least partially arranged vertically one above the other, and because the floating frame arrangement has one frame portion per module, and/or further because the floating frame arrangement is at least partially made of translucent plastic material, e.g., acrylic glass resistant to sea water and the action of UV radiation, and/or is provided with light-bundling elements, such as converging lenses or a mirror structure or mirror coating. The frame is used simultaneously for the evaporation system and water uptake system/conduit system in addition to its supporting and coupling function. To absorb thermal radiation, the translucent tubes can be coated black, e.g., with a film or paint, on their lower side facing away from the sun, preferably on the inside, and/or be lined with heat-insulating material on their side facing away from the sun.

A further advantageous embodiment of the clean water production system consists in the floating frame arrangement having at least one hollow tube provided with passage openings, in particular in its geodetically upper region, and through which the water vapor of the evaporated water can be suctioned off to produce the clean water. The air enriched with the evaporated water vapor can be advantageously suctioned out via the tube system itself or the sieve-like or lattice-like passage openings in the upper region of the particularly inherently stable hollow tube(s) and fed to the condensation device. The suction device consists in particular of a vacuum suction pump which is operated, for example, by means of electrical energy generated by solar energy (photovoltaics) and/or wind energy (wind generator).

Further advantageous design variants of the clean water production system consist in the concentrator system for densifying the sun rays by bundling having at least one converging lens arrangement and/or at least one collecting mirror arrangement. In order to achieve the highest possible thermal energy collection, the concentrator system can be designed or installed to track the position of the sun according to the time of day and/or optionally the season. The converging lens arrangement can advantageously be designed as a stepped lens arrangement/Fresnel lens arrangement, so that as little material as possible is required for its construction.

In an advantageous embodiment for further use, the clean water production system comprises the hydrogen production device for producing hydrogen by electrolysis from the evaporated water and/or the clean water.

For the operation and use of the clean water production system, it is further advantageously provided that it have the photovoltaic device for providing electrical energy, in particular for operating a suction unit of the suction device and/or the hydrogen production device. Electrical energy can additionally or alternatively be generated by means of a wind turbine (which is of correspondingly lightweight construction), arranged in particular on a support device on the floating frame, which turbine can supply electrical energy even when there is little or no solar radiation. The electrical energy can advantageously be stored, unless it is required for operation, in a storage system that is also provided. For additional electrical energy generation, generators are also conceivable that generate electrical energy from the wave movement of the surrounding water. For example, small amounts of energy are sufficient to operate a low-power suction device.

An advantageous embodiment consists in the water supply device having a valve arrangement which prevents water from flowing back from the irradiated water surface region to the water surface.

A further advantageous embodiment consists in a water uptake layer being provided or wick-like elements being provided for the transport of water from the water surface by capillary action upwards into the irradiated water surface region, and the concentrator system being arranged relative to the geodetically upper side of the water uptake layer during use in such a way that water absorbed is evaporated or vaporized by the thermal energy of the supplied or condensed sun rays.

By means of the clean water production system thus formed with the water uptake layer, the evaporation of the water can be increased by means of the thermal energy obtained from the condensed solar radiation provided in the region of the surface of the water uptake layer compared to direct radiation onto the water surface, since cooling effects are significantly reduced by the water volume underneath. At the same time, there is a certain degree of self-regulation for the supply of water, since the amount of water supplied by capillary action also depends upon the heat supply according to the time of day, and the resulting amount of evaporation. The water uptake layer can be adapted in its water transport properties to the expected (e.g., an average) degree of evaporation in order to achieve the most efficient possible clean water production, wherein in particular the thickness of the water uptake layer (e.g., between 1 cm and 1 dm or multiple dm), the choice of material, and/or the capillary arrangement, formation, size, and density can be optimized to achieve optimal water transport to the surface. For example, sponge-like or fleece-like material or knitted textile made of an artificial and/or natural substance (especially fibers) can be used to form the corresponding cavities or pores or channels for the capillary action, and the mat-like absorption layer can be rigid or flexible to a certain degree. The water can thus be metered into the surface region of the water uptake layer. This simultaneously creates a calmed evaporation zone. Salt-and dirt-repellent material can be selected, an easy-to-clean or self-cleaning coating can be formed on the underside of the water uptake layer, or a water-permeable (e.g., perforated) coating can be applied in an interchangeable manner.

Various advantageous embodiments of the application further consist in the water uptake layer being designed as a mat-like layer which lies on the water surface during use or which is partially immersed in it over its thickness, having cavities acting as capillaries, being self-floating, and/or supported on the water surface by being connected to the floating frame arrangement.

For continuous operation of the hydrogen production device in different weather conditions, it is also advantageous that fresh water can be additionally supplied to the water surface region via a supply system.

For efficient utilization of existing solar radiation, it is advantageously provided that it have a tracking device by means of which the concentrator system can track the position of the sun in order to generate the highest possible radiation density on the irradiated water surface region. The tracking device is designed at least to track the position of the sun according to the time of day, but can also be designed to track the position of the sun according to the season for more precise alignment and even more effective use of the radiation power. A control device is advantageously provided for tracking. This allows the time-of-day-dependent tracking to be carried out azimuthally and the season-dependent tracking to be carried out according to the elevation and/or altitude angle.

A further advantageous embodiment of the operation consists in solar modules of the photovoltaic device, which are exposed to solar radiation alone or in addition, being able to track the position of the sun by means of the tracking device.

An advantageous design for the structure and function consists in the tracking device having a circularly curved hydraulic cylinder as a drive system, at least for the time-of-day-dependent sun position tracking. Such a circular hydraulic cylinder and/or rotary piston machine is disclosed, for example, in DE 10 2007 001 021B4 . It can be made of corrosion-resistant material and/or durable plastic.

An advantageous design of the clean water production system with regard to solar radiation conditions (such as duration of sunshine throughout the year, geographical location) and local or spatial conditions, and also optionally with regard to performance or power requirements, is achieved by having modules of the same or different types, at least in part, in terms of geometry and/or function.

An advantageous adaptation option for this is a modular system for constructing a clean water production system, wherein multiple combinable modules of an A-type are present for constructing the water evaporation device, and/or multiple combinable modules of a B-type are present for constructing a photovoltaic device, wherein it can advantageously also be provided that a plurality of modules of a C-type be present for constructing a hydrogen production device, and wherein at least two modules of different types are present.

The invention is explained in more detail below by means of examples with reference to the drawings, in which:

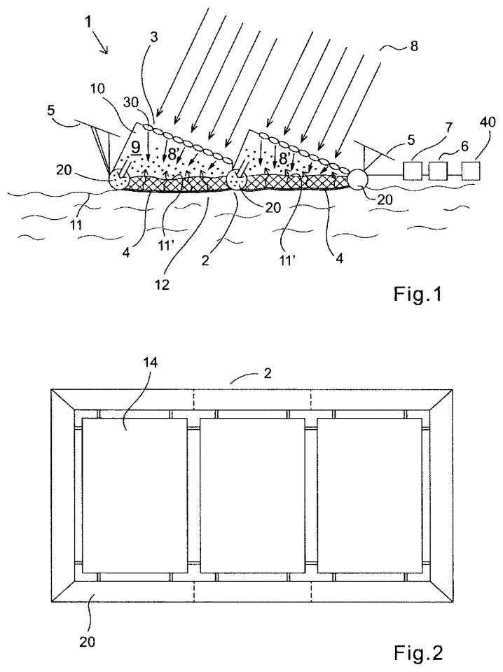

FIG. 1 is a schematic cross-sectional view of a clean water production system with a water evaporation device,

FIG. 2 is a schematic view of a clean water production system composed of a plurality of modules,

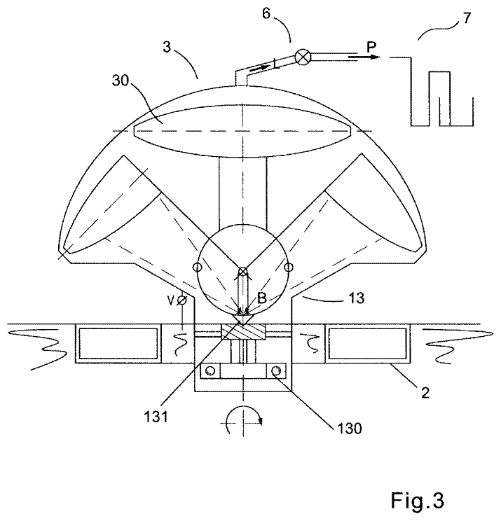

FIG. 3 shows an exemplary embodiment of a tracking device for the clean water production system with connected components in a schematic view,

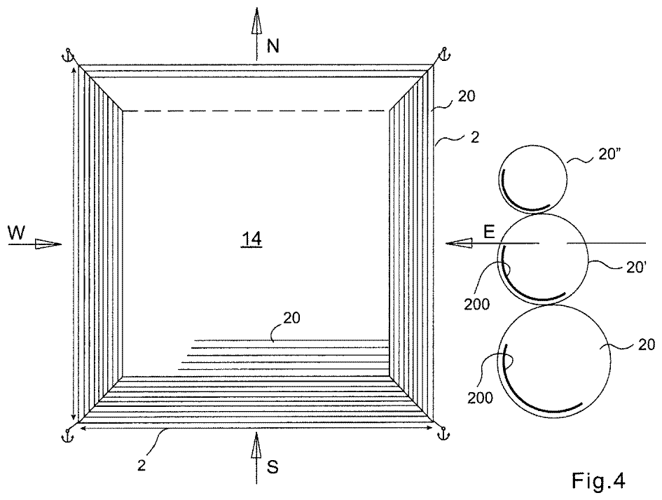

FIG. 4 shows a schematically illustrated module of, for example, an A-type (water evaporation device function),

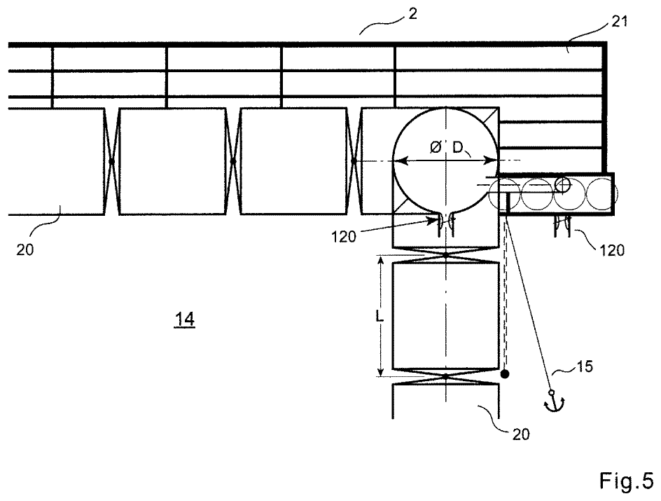

FIG. 5 is a schematic representation of a corner region of a module of, for example, an A-type.

A clean water production system 1 according to the invention, shown as an example in FIG. 1, has a floating frame arrangement 2, which is also used as a support frame for a concentrator system 3 for incoming sun rays 8, held thereon by means of a support system, wherein the floating frame arrangement 2 is designed to float on the water surface 11—for example, a sea water surface. A water supply device 12 is arranged in the region of the water surface 11 surrounded by the floating frame arrangement 2.

In the exemplary embodiment shown in FIG. 1, the water supply device 12 is designed as a water uptake layer 4, which itself is designed to float on the water surface, partially or completely submerged over its thickness, and is held on the floating frame 2 by means of suitable fastening means. The (geodetically) upper side of the water supply device 12, e.g., the water uptake layer 4, is spaced from the rear side opposite the side facing the sun of the concentrator system 3, such that the sun rays 8 condensed or bundled by the concentrator system 3 are directed onto the region of the upper side of the water supply device 12 or the water uptake layer 4 as evenly as possible. The concentrator system 3 and the water supply device 12, as well as the water uptake layer 4, form essential components of a water evaporation device 10, wherein the water supply device 12 or water uptake layer 4 acts as a transport system for the water from the water surface 11 (in particular, sea surface or lake) into the surface region of the water uptake layer 4 by means of capillary action. As an alternative to the water uptake layer 4 shown, the water supply device 12 can be designed as an arrangement with a valve device 120, via which water is supplied from the water surface 11 in a metered manner in accordance with the radiation power supplied to the irradiated water surface region or the radiation energy supplied over time for the most effective evaporation possible.

The concentrator system 3, which has elements 8 which condense or focus the incoming sun rays, such as a converging lens arrangement (e.g., in the form of Fresnel lenses) and/or a converging mirror arrangement, is spaced and positioned with respect to the upper side of the water supply device 12 or water uptake layer 4 such that its surface is close to or in the focal point of the converging lens or mirror elements, so that, in the region of the surface, i.e., also somewhat below it (in the thickness direction, e.g., by half, a third, or a quarter of the thickness below the surface), a significant heating of the water transported to the surface is achieved for the most effective evaporation possible—in any case, a significantly stronger evaporation than without a concentrator system. The number of lens or mirror elements concentrating the sun rays 8 is advantageously adjusted to ensure the most effective evaporation of the water transported in accordance with the transport properties and also the thermal conductivity properties of the water supply device 12 and/or the water uptake layer 4. Advantageously, the points of incidence of the main rays (not necessarily the focal points) of the bundled beams are largely evenly distributed on the surface of the irradiated water surface region or the water uptake layer 4, so that a locally homogeneous heat distribution in the region of the surface of the irradiated water surface region or the water uptake layer 4 is achieved. The uniformity of the heat distribution depends, among other things (in addition to the distance and concentration of the condensed beams), also upon the thermal conductivity of the water uptake layer 4, such as a corresponding plastic material, thermally conductive, porous ceramic material, possibly also metallic material (e.g., when using a wire mesh at least in the region of the surface of the water supply device 12, such as the water uptake layer 4) or even natural fiber material or a material combination of such materials, wherein a suitable metered supply is produced by, for example, capillary action.

The water evaporated or vaporized on the surface of the water supply device 12 such as the water uptake layer 4 rises in particular in the area below the concentrator system 3 and is suctioned out of this space by means of a suction device having a suction unit 6. For this purpose, the floating frame 2 is advantageously equipped, for example, at least partially with buoyant, in particular inherently stable, hollow tubes 20, through which the water vapor 9 of the evaporated water is suctioned off. Additionally or alternatively, as shown in FIG. 3, a dome-shaped collecting screen, to which a suction unit 6 is connected, may be provided to collect the water vapor.

To obtain the clean water, the water vapor is passed through a condensation device 7, and the resulting condensate is collected as clean water. The hollow tubes 20 are provided in their (geodetically) upper region with, for example, sieve-like or lattice-like passage openings through which the air enriched with the water vapor 9 is suctioned out, as indicated by the broad arrows in FIG. 1. Condensation water already formed in the hollow tubes 20 (due to the cooling effect of the surrounding water volume) can also be collected and used for clean water production. The floating frame arrangement with the transparent hollow tubes forms at least part of the concentrator system for collecting the sun rays and/or the thermal energy supplied by them.

In order to achieve the greatest possible energy yield from solar radiation, the clean water production system 1 advantageously has a tracking device 13, which is constructed, for example, according to FIG. 3. The tracking device 13 serves in particular to track the concentrator system 3 according to the position of the sun over the course of the day. In addition, the tracking can be adjusted to the height of the sun over the course of the year. For example, for the time-of-day-dependent tracking, a (geodetically) horizontally arranged first hydraulic cylinder 130 in a circular design is provided, while, for the season-dependent course of the sun's position, a second circular hydraulic cylinder 131 is provided for tracking, arranged in a plane perpendicular to the plane of the first hydraulic cylinder 130. This allows tracking in the azimuthal direction and, optionally, in the elevation direction. Such circular hydraulic cylinders are disclosed in the aforementioned DE 10 2007 001 021B4 . In the present case, they are made of a material suitable for use in water, e.g., salt water, which is corrosion-resistant, made for example of durable plastic, or are provided with a moisture-proof encapsulation. The tracking device 13, with the drive system designed in this way, for example, has a control device, in particular a regulating device for precise tracking according to the position of the sun.

In order to provide electrical energy, e.g., for operating the suction unit 6, a photovoltaic device 5 is advantageously present, which is attached, for example, to the floating frame arrangement 2 by means of a supporting structure, or to which a separate module 14 is assigned—for example, with its own partial floating frame arrangement. Alternatively or additionally, to generate electrical energy, a wind power plant or wind turbine (small design) can be installed in particular on the floating frame arrangement 2, and the clean water production system 1 can also comprise suitable storage components to store electrical energy.

Advantageously, the clean water production system 1 is provided with a hydrogen production device 40 which produces hydrogen from the clean water, obtained on the basis of electrolysis, wherein the electrical energy is also provided by the photovoltaic device 5 and/or the additional electrical energy sources.

For clean water production and/or hydrogen production on a larger scale, the clean water production system 1 can be designed with a correspondingly large area or can be designed to form a cascade of a plurality of smaller (e.g., rectangular or square) clean water production systems 1, which are composed, for example, of individual modules 14, as shown schematically in FIG. 2.

The clean water production system 1 can be composed of several similar and/or dissimilar modules 14, which can be provided, for example, as components of a modular system. Similar modules 14 correspond in their structural and geometric design and have the same function, whereas dissimilar modules 14 differ in their structural design, their geometry, and/or their function. Modules 14 of an A-type, for example, correspond in their function to the water evaporation device 10 and are provided with an adapter device, allowing them to be assembled as a plurality of modules of this type, forming an enlarged, more powerful water evaporation device 10 compared to their use individually. Modules 14 of a B-type correspond in their function to a photovoltaic device 7 and have adapter devices to combine them into a larger, more powerful photovoltaic device 7 made of a plurality of modules of this type. Modules 14 of a C-type correspond in their function to a hydrogen production device 40 and have adapter devices to combine them into a larger, more powerful hydrogen production device 40 made of a plurality of modules of this type. It is also possible to assemble a clean water production system 1 of variable size and geometric shape from at least two modules 14 of different types, so that the user can assemble a clean water production system 1 that is advantageous for him according to his needs and local conditions.

As shown in FIG. 2, the modules 14 can, for example, have a rectangular shape of the same length and width and can be assembled in a row along their long sides via the adapter device and surrounded by a shared floating frame arrangement 2. An advantageous embodiment also consists in each module 14 being provided with its own floating frame arrangement 2 and the floating frames being provided with adapter devices, so that the modules 14 can be connected to one another via their floating frames. The adapter devices have mechanical connecting elements for quick coupling with each other and can also be designed in such a way that they include a functional coupling, e.g., for energy transmission. Thus, for example, a water evaporation device 10 having at least one A-type module 14 in combination with at least one B-type module 14 as a photovoltaic device 7 can advantageously be supplied with power. A clean water production system 1 can be used which has a water evaporation device 10 of selectable size or a photovoltaic device 7 of selectable size as a function of the intensity of the solar radiation—for example, as a function of the geometric width. A clean water production system can be assembled in a bay, or adjacent to an industrial plant, adapted to the course of a coastline and with a selectable length or width, and can also be combined in a suitable shape. For this purpose, modules 14 of different geometric shapes and/or sizes, such as triangular, rectangular, square, hexagonal, or other shapes, are advantageously provided, which can be assembled, for example, in the manner of a mosaic or puzzle.

To calm wave movements, an arrangement of aprons can be provided around the clean water production system 1.

To remove or reduce salt or dirt deposits, the clean water production system 1, in particular the water supply device 12, such as the water uptake layer 4, is provided with easily cleanable materials, in particular on the surface facing the salt water, or with a replaceable coating that is water-permeable where necessary.

FIG. 4 shows a schematic representation of a module 14 with a square outer geometry—for example, an A-type module with the function of a water evaporation device. In order to obtain as much solar energy as possible throughout the day for heating the exposed water surface region or the corresponding water volume, one side of the module is substantially oriented towards the East (E), so that the clockwise adjoining sides are oriented accordingly towards the South(S), West (W), and North (N). On the East side, transparent hollow tubes 20 or, if appropriate, tube portions movably coupled to one another via intermediate parts run parallel to the corresponding module side or in the direction of the corresponding side of the floating frame arrangement 2 and thus at right angles to the East direction, so that large-area thermal radiation is absorbed by the hollow tubes 20, which are advantageously constructed from acrylic glass and which, in this embodiment, form part of the solar radiation concentrator system. The aim is to capture and couple the thermal energy supplied by the sun as effectively as possible in order to evaporate and/or vaporize the heated sea water volume under the corresponding water surface region as effectively as possible. For example, the diameter of the hollow tubes 20 is in the range between ca. 10 cm and 80 cm, with a wall thickness of the highly transparent wall, in particular made of acrylic glass, of ca. 1 mm or several millimeters, resulting in, for example, a light transmittance of between 80% and 95% of the incoming solar radiation. Temperatures between 50° C. and 80° C., e.g., between 60° C. and 70° C., for a relatively high degree of evaporation, are achieved inside the hollow tube 20. On the side facing away from the direction of incidence, the hollow tubes 20 can be provided with a black inner coating 200 and/or have a heat insulation layer made of heat-insulating material in order to keep the heat as well as possible inside the hollow tube 20. Evaporated water can then be removed through the interior of the hollow tube by means of the suction device and collected, in particular in condensed form, in the collection device as clean water. If a tube system is provided with multiple tube portions, the connecting regions in the form of intermediate parts are provided with suitable flow-through passages for the air laden with water vapor to flow through. The thermal insulation layer, which is preferably arranged inside the hollow tubes 20 and can have a thickness of ca. 0.5 cm to 10 cm, for example, leads to a reduction in the internal air volume of the hollow tubes, wherein the internal air volume can heat up correspondingly quickly.

As FIG. 4 further shows, in the corresponding edge region of the module 14, for example, multiple hollow tubes 20, 20′, 20″ running horizontally along the corresponding module side are arranged vertically or slightly obliquely to one another in order to absorb as much solar radiation as possible in their tube interior and to evaporate any water present therein by means of the heat generated. In the lower hollow tube 20 of the tube system, sea water can be introduced via a water supply device 12 of the structure described above. Water to be evaporated can be introduced into the hollow tubes 20′, 20″ arranged above, e.g., via low-power pumps or passively, e.g., via capillary action, such as wick elements, e.g., in coordination with the degree of evaporation with a corresponding active control, or in a self-regulating manner. The air laden with water vapor can then be discharged by means of the drainage device as described above and, in particular after condensation, collected.

As can be further seen from FIG. 4, the tube system allows for the advantageous use of solar radiation coming from the East E after sunrise. Accordingly, the tube system can be constructed, on the west side W, to utilize solar radiation coming from the West before sunset. Meanwhile, solar radiation coming over the southern sky is utilized via a tube arrangement with horizontal tubes running transversely to the southern direction of incidence S, which in this case is arranged at right angles to the southern direction S. In order to make the most extensive use of the solar radiation from the South, which makes the essential contribution, the arrangement of the hollow tubes 20 arranged transversely or at right angles to the southern direction S is advantageously distributed completely or largely completely over the entire module surface of the corresponding module 14 enclosed by the floating frame arrangement 2, wherein the hollow tubes 20 are designed to be translucent in the manner described above, in particular made of acrylic glass, advantageously coated black on the inside and optionally thermally insulated, and are supplied with water to be evaporated via a water supply device constructed in the manner described above.

In order to also use the floating frame arrangement 2 of the other B-type or C-type modules for the additional production of clean water by heating it up by solar radiation, the floating frame arrangements 2 of these modules can also be provided with a tube system, as is used in the A-type modules for the East side and West side (e.g., also on the South side). Thus, the floating frame arrangement 2 of module types B and C can also contribute to the clean water production of the clean water production system, in addition to its supporting function. The tube system of a floating frame arrangement supporting the entire system can be designed accordingly.

FIG. 5 shows an example of a corner region of a module 14, e.g., of the A-type, with hollow tubes 20 formed from multiple tube portions of a length L via movable connecting regions. Water to be evaporated is supplied to the interior of the hollow tubes—for example, via a valve device 120 or, for example, by means of capillary action. In order to be able to access the modules, e.g., for inspection or maintenance purposes, in this exemplary embodiment, a walkway 21 is arranged around the outside of the floating frame arrangement 2, at least in sections. The walkway 21 can also be at least partially transparent (e.g., by means of acrylic glass) and provided with cavities in order to heat water or sea water to be evaporated therein by means of solar energy and to use it for the production of clean water after evaporation. A cross-section of a tube portion with diameter D and of a valve for admitting water to be evaporated is shown schematically. FIG. 5 also shows an anchor 15 as an example, such as can be used, e.g., in all four corner regions, for anchoring the respective modules 14 and/or for anchoring the clean water production system to a plurality of modules 14. Similarly, modules 14 of other geometric shapes can be anchored at a suitable location, e.g., in a bay.

1. Clean water production system (1) having a water evaporation device (10) which can be arranged to float on a water surface (11), in particular a sea water surface, and which has a concentrator system (3) for densifying and directing sun rays (8) onto a water surface region (11) within the floating frame arrangement (2), and has a water supply device (12), arranged between the water surface (11) and the water surface region (11′) exposed to the concentrated sun rays, which is designed for the metered supply of water from the water surface (11) into the irradiated water surface region (11′), so that water is evaporated in the irradiated water surface region (11′) by the thermal energy of the concentrated sun rays (8′), wherein the clean water production system (1) further has a drainage device by means of which the evaporated water can be supplied, in particular via a condensation device (7), to a clean water collection point, and has at least one mechanically and functionally integrated hydrogen production device (40) and/or a photovoltaic device (7),
characterized in that
the clean water production system (1) is composed of a plurality of modules (14) which are held together by means of a floating frame arrangement (2), wherein at least one module is designed as an A-type which comprises a water evaporation device (10), and at least one further module is designed as a B-type which comprises a photovoltaic device (7), or is designed as a C-type which comprises a hydrogen production device (40), or in that a plurality of further modules are present, of which at least one is designed as a B-type module and at least one as a C-type module.

2. Clean water production system according to claim 1,
characterized in that
the floating frame arrangement (2) is at least partially tubular for conducting evaporated water to the clean water collection point, wherein multiple tubes arranged vertically one above the other can also be present at least partially, and
the floating frame arrangement (2) has one frame portion per module (14).

3. Clean water production system according to claim 1 or 2,
characterized in that
the floating frame arrangement (2) is formed at least in portions from translucent plastic material and/or is provided with light-bundling elements, such as converging lenses or a mirror structure or mirror coating.

4. Clean water production system according to any of the preceding claims,
characterized in that
the floating frame arrangement (2) has at least one hollow tube (20) provided with passage openings, in particular in its geodetically upper region, and through which the water vapor (9) of the evaporated water can be suctioned off to obtain the clean water.

5. Clean water production system according to any of the preceding claims,
characterized in that
the concentrator system (3) for densifying the sun rays by bundling has at least one converging lens arrangement (30) and/or at least one converging mirror arrangement.

6. Clean water production system according to any of the preceding claims,
characterized in that
the hydrogen production device (40) is designed to produce hydrogen from the evaporated water or the obtained clean water by electrolysis.

7. Clean water production system according to any of the preceding claims,
characterized in that
electrical energy provided by the photovoltaic device (7) is used for the clean water production system (1), in particular for operating a suction unit (6) of the suction device and/or the hydrogen production device.

8. Clean water production system according to any of the preceding claims,
characterized in that
the water supply device (12) has a valve arrangement (120) which prevents water from flowing back from the irradiated water surface region to the water surface (11), and/or,
for transporting water from the water surface (11) by capillary action upwards into the irradiated water surface region, the water supply device (12) has a water uptake layer (4), wherein the concentrator system (3) is arranged relative to the geodetically upper side of the water uptake layer during use such that the supplied water is evaporated by the thermal energy of the condensed sun rays (8).

9. Clean water production system according to claim 8,
characterized in that
the water uptake layer (4) is designed as a mat-like layer which, when in use, rests on the water surface (11) or is partially immersed in the water surface over its thickness, has cavities acting as capillaries, and is carried on the water surface (11) in a self-floating manner and/or by being connected to the floating frame arrangement (2).

10. Clean water production system according to any of the preceding claims,
characterized in that
fresh water can be added to the water surface region via a supply system.

11. Clean water production system according to any of the preceding claims,
characterized in that
it has a tracking device (13) by means of which at least parts of the concentrator system (3) can track the position of the sun in order to generate the highest possible radiation density on the irradiated water surface region, and/or
solar modules of the photovoltaic device (7) which are exposed to solar radiation can also track the position of the sun by means of the tracking device (13).

12. Clean water production system according to claim 11,
characterized in that
the tracking device (13) has a circularly curved hydraulic cylinder as a drive system at least for the time-of-day-dependent sun position tracking.

13. Clean water production system according to any of the preceding claims,
characterized in that
modules (14) with similar or dissimilar geometry are present.

14. Modular system for constructing a clean water production system according to any of the preceding claims,
characterized in that
multiple combinable modules (14) of an A-type are present for constructing the water evaporation device (10), and/or
multiple combinable modules (14) of a B-type are present for constructing a photovoltaic device (7).

15. Modular system according to claim 14,
characterized in that
multiple combinable modules (14) of a C-type are also present for constructing a hydrogen production device (40).
